(19) United States
(12) Patent Application Publication
(10) Pub. No.: US 2026/0359423 A1
(43) Pub. Date: Nov. 12, 2026

(54) Antimalware Systems and Methods Using Artificial Intelligence to Analyze the Call Stack

(71) Applicant: Bitdefender IPR Management Ltd., Nicosia (CY)

(72) Inventors: Andrei V. LUTAS, Cluj-Napoca (RO); Nicolae BODEA, Cluj-Napoca (RO); Andrei KISARI, Dej (RO); Ionel C. ANICHITEI, Dorna-Arini (RO)

(21) Appl. No.: 19/204,950

(22) Filed: May 12, 2025

(51) Int. Cl. G06F 21/54; G06F 21/55

(52) U.S. Cl. CPC G06F 21/54; G06F 21/552; G06F 21/556

(57) ABSTRACT

Anti-malware systems and methods described herein use an artificial neural network to analyze metadata determined according to a current call stack of a target software entity. Security software parses a snapshot of the call stack and for each address on the stack, extracts a set of metadata characterizing a memory page referenced by said address. Exemplary page metadata includes the name of a software module/library residing within the respective page, access rights to the respective page, and an allocation type of the respective page, among others. Page metadata collected for multiple stack references are ordered according to a position of each respective reference on the stack and fed to an artificial neural network unit pre-trained to distinguish between benign and malicious stack traces.

### BACKGROUND OF THE INVENTION

The invention relates to computer security, and in particular to protecting computers against malicious software (malware).

Malicious software affects a great number of computer systems worldwide. In its many forms such as computer viruses, worms, rootkits, spyware, and ransomware, malware presents a serious risk to millions of computer users, making them vulnerable to loss of data and sensitive information, identity theft, and loss of productivity, among others.

Security software employs a variety of methods and strategies to combat malicious software. Some such methods try to match the contents of memory against a pre-determined library of malicious code snippets and patterns, commonly known as signatures. Other exemplary methods monitor the execution of selected software entities, looking for patterns of behavior that are indicative of malice.

Malware detection and mitigation face substantial technical challenges. Activities related to behavior monitoring and signature matching are computationally costly and may adversely affect productivity and user experience. Some components of the security software are themselves vulnerable to attack. Last but not least, malware constantly evolves to evade detection. Therefore, there is a persistent interest in developing novel, efficient, and robust anti-malware systems and methods.

### SUMMARY OF THE INVENTION

According to one aspect, a computer system comprises at least one hardware processor configured to execute a stack parser and an artificial neural network connected to the stack parser. The stack parser executes concurrently with a target process and is configured to, in response to an occurrence of a trigger event caused by an execution of the target process, determine a stack descriptor characterizing a plurality of stack references of a call stack of the target process, wherein for each stack reference of the plurality of stack references, the stack descriptor comprises a plurality of metadata characterizing a memory page pointed to by the each stack reference. The artificial neural network is configured to determine whether the computer system comprises malicious software according to the stack descriptor.

According to another aspect, an anti-malware method comprises employing at least one hardware processor of a computer system to, in response to an occurrence of a trigger event caused by an execution of a target process, determine a stack descriptor characterizing a plurality of stack references of a call stack of the target process, wherein for each stack reference of the plurality of stack references, the stack descriptor comprises a plurality of metadata characterizing a memory page pointed to by the each stack reference. The method further comprises employing an artificial neural network to determine whether the computer system comprises malicious software according to the stack descriptor.

According to another aspect, a non-transitory computer-readable medium stores instructions which, when executed by at least one hardware processor of a computer system, cause the computer system to form a stack parser and an artificial neural network connected to the stack parser. The stack parser executes concurrently with a target process and is configured to, in response to an occurrence of a trigger event caused by an execution of the target process, determine a stack descriptor characterizing a plurality of stack references of a call stack of the target process, wherein for each stack reference of the plurality of stack references, the stack descriptor comprises a plurality of metadata characterizing a memory page pointed to by the each stack reference. The artificial neural network is configured to determine whether the computer system comprises malicious software according to the stack descriptor.

### BRIEF DESCRIPTION OF DRAWINGS

The foregoing aspects and advantages of the present invention will become better understood upon reading the following detailed description and upon reference to the drawings where:

FIG. 1 shows a set of software components executing on a host system according to some embodiments of the present invention.

FIG. 2 illustrates exemplary components of a security application according to some embodiments of the present invention.

FIG. 3 shows an exemplary call stack and a set of exemplary software modules (e.g., libraries) referenced by the call stack, according to some embodiments of the present invention.

FIG. 4 shows determining a feature vector characterizing a stack entry according to some embodiments of the present invention.

FIG. 5 illustrates constructing a stack descriptor characterizing the call stack according to some embodiments of the present invention.

FIG. 6 shows exemplary components and operation of an artificial intelligence (AI) unit according to some embodiments of the present invention.

FIG. 7 shows an exemplary sequence of steps performed by a security application according to some embodiments of the present invention.

FIG. 8 shows an exemplary hardware configuration of a host system programmed to execute some of the methods described herein.

### DETAILED DESCRIPTION OF THE INVENTION

In the following description, it is understood that all recited connections between structures can be direct operative connections or indirect operative connections through intermediary structures. A set of elements includes one or more elements. Any recitation of an element is understood to refer to at least one element. A plurality of elements includes at least two elements. Any use of ‘or’ is meant as a nonexclusive or. Unless otherwise required, any described method steps need not be necessarily performed in a particular illustrated order. A first element (e.g., data) derived from a second element encompasses a first element equal to the second element, as well as a first element generated by processing the second element and optionally other data. Making a determination or decision according to a parameter encompasses making the determination or decision according to the parameter and optionally according to other data. Unless otherwise specified, an indicator of some quantity/data may be the quantity/data itself, or an indicator different from the quantity/data itself. A computer program is a sequence of processor instructions carrying out a task. Computer programs described in some embodiments of the present invention may be stand-alone software entities or sub-entities (e.g., subroutines, libraries) of other computer programs. A process is an instance of a computer program, such as an application or a part of an operating system, and is characterized by having at least an execution thread and a section of virtual memory assigned to it, the respective section storing executable code. A page represents the smallest unit of virtual memory individually mapped to a physical memory of a host computer system. Metadata herein encompasses any data that provides information about an object, apart from the object itself. For instance, page metadata may include an allocation type and an access permission of the respective memory page, but not the content of the respective memory page. A hash is the output of a hash function. Hash functions perform a mapping that minimizes collisions (i.e., distinct inputs that produce an identical output). Computer-readable media encompass non-transitory media such as magnetic, optic, and semiconductor storage media (e.g., hard drives, optical disks, flash memory, DRAM), as well as communication links such as conductive cables and fiber optic links. Volatile media (e.g., DRAM) retain their content only while powered, in contrast to non-volatile media (e.g., magnetic hard disk, flash memory) whose contents persist when powered down. According to some embodiments, the present invention provides, inter alia, computer systems comprising hardware (e.g., one or more processors) programmed to perform the methods described herein, as well as computer-readable media encoding instructions to perform the methods described herein.

Embodiments of the present invention enable protecting a host system against malware. Exemplary host systems protected as described herein include personal computers, corporate mainframe computers, mobile computing platforms (e.g., laptop computers, tablets, smartphones), entertainment devices (e.g., TVs, game consoles), wearable devices (e.g., smartwatches, fitness bands), household appliances (e.g., smart lighting systems, door locks, thermostats, refrigerators), network appliances (e.g., routers, switches, etc.), and generally any other electronic device comprising a hardware processor and a memory.

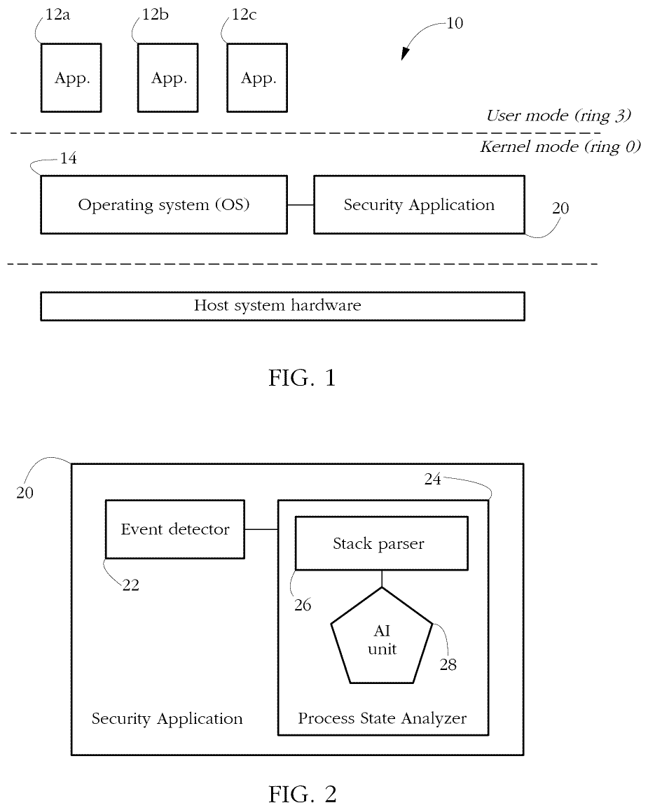

FIG. 1 shows exemplary software components executing on a host system 10 according to some embodiments of the present invention. FIG. 1 is rendered from the perspective of processor privilege levels, also known in the art as rings (on x86 processor platforms) and exception levels (ARM® processor platforms). A set of software applications 12a-c execute at a relatively low ‘user’ level of processor privilege, also known as ‘user mode’ or ring 3 on x86 platforms. Applications 12a-c generically represent any computer program, such as a browser, a productivity application (e.g., word processor, spreadsheet, etc.), a gaming application, a social media application, and an electronic communication application (e.g., email client, instant messenger, etc.), among others.

An operating system 14 executes at a more privileged level than applications 12a-c, commonly known as ring 0 or kernel mode on x86 platforms. OS 14 acts as an intermediary between user applications 12 and the hardware of host system 10 (such as memory, input and output devices, and communication interfaces, among others. Furthermore, OS 14 may carry out various administrative tasks collectively ensuring a smooth and efficient execution of applications 12, for instance manage process/thread scheduling and execution, construction and maintenance of data structures describing each executing entity (process, thread), manage memory allocation, memory mapping, loading an image of each computer program and its required dependencies into memory, pushing and popping data onto/off the stack, etc. Examples of OS 14 include any instance of Microsoft® Windows®, Linux®, Android®, and iOS® operating systems, among others.

In some embodiments, a security application 20 executes at a kernel level of processor privilege (ring 0, kernel mode) and is configured to protect host system 10 against computer security threats such as malware. Application 20 may be a standalone computer program or may be a part of a larger security suite comprising, for instance, software protecting users against online fraud and/or unsolicited communications (spam), and software providing encrypted communication channels (e.g., virtual private networking—VPN), among others.

In some embodiments as illustrated in FIG. 2, security application 20 comprises an event detector 22 communicatively coupled to a process state analyzer 24. Application 20 may execute concurrently with user applications 12a-c and employ event detector 22 to listen for specific computing events caused by the execution of applications 12a-c, herein deemed ‘trigger events’ since their detection typically triggers an analysis of various data structures currently stored in memory for the purpose of detecting malware. Exemplary trigger events include events indicative of a specific stage in the lifetime of an executable entity, the respective stage singled out for being particularly informative as to whether the respective executable entity is malicious or not. Such stages are herein deemed ‘inspection points’; some examples include loading an image of the respective process from non-volatile storage (e.g., hard disk) to memory, loading of an executable module (e.g., library) into memory, launching a process into execution, spawning a child process, creating a thread, connecting to a network socket, creating a pipe, accessing a registry key, and accessing a file, among others.

Event detector 22 may detect trigger events using any method known in the art of computer security. Preferred embodiments register selected event types with an event-reporting application programming interface (API) of OS 14. For instance, in Windows®, a driver may subscribe to be notified by the kernel in response to specific events, via a mechanism known as ‘kernel callback’. Alternative methods may involve hooking, a generic term for intercepting function calls, messages, or events passed between software components. One exemplary hooking method comprises altering the entry point of a target function by inserting an instruction redirecting execution to a second function. Following such hooking, the second function may be executed instead, before, or after the target function. For instance, when a process calls for some OS functionality, e.g. to allocate a section of memory, or to write something to a disk file, the respective processor instruction calls a user-mode API library such as kernel32.dll or ntdll.dll on Windows® platforms. To detect such a call, some embodiments may alter the respective function to redirect execution to event detector 22, thus notifying security application 20 of the call.

However, performing the interception of a trigger event from a user level of processor privilege may result in contaminating the call stack with items pushed on the stack by the hook functions performing the actual interception. To avoid unwanted modifications to the call stack, some embodiments may prefer intercepting trigger events at kernel level and/or system call level, over intercepting at user level. Alternatively, in some embodiments, the malware analysis of the target thread/process (see below) may be performed by a second thread owned by security application 20 and therefore distinct from the target thread. The security thread thus executes concurrently with the target thread, but in kernel mode. In typical embodiments, the security thread is synchronized with the target thread for the duration of the analysis, so that the target thread is not contaminated by software components performing the interception and/or the actual malware analysis.

In response to event detector 22 detecting a trigger event, some embodiments suspend execution of the target thread for the duration of malware analysis, thus freezing the current state of the respective process, i.e., the state at the current inspection point. The state of a process herein denotes the current contents of its memory space, including current values of all variables, the call stack, and all executable modules/libraries loaded by the respective process.

In some embodiments, process state analyzer 24 is configured to examine the state of the respective process for indicators of malice. However, the state may comprise a vast volume of data so that inspecting all of it carries a substantial computational cost, negatively affecting user experience. Some embodiments rely on the observation that practically all software components that are relevant and consequential for the current inspection point (i.e., current stage within the life cycle of the current user-mode process) are referenced by the call stack. Stated otherwise, any malicious software executing at or immediately following of the current inspection point most likely resides within memory regions referenced by addresses currently present on the stack. Embodiments of the present invention therefore use the content of the user-mode call stack to efficiently zoom in on relevant memory regions, which vastly reduces the search space and computational expense associated with malware detection.

In such embodiments, process state analyzer 24 includes a stack parser 26 providing input to an artificial intelligence (AI) unit 28. Parser 26 is configured to walk the current user-mode stack (i.e., call stack of a target user application 12a-c frozen at the current inspection point) to identify and characterize a set of memory regions storing a part of the state of the respective target application.

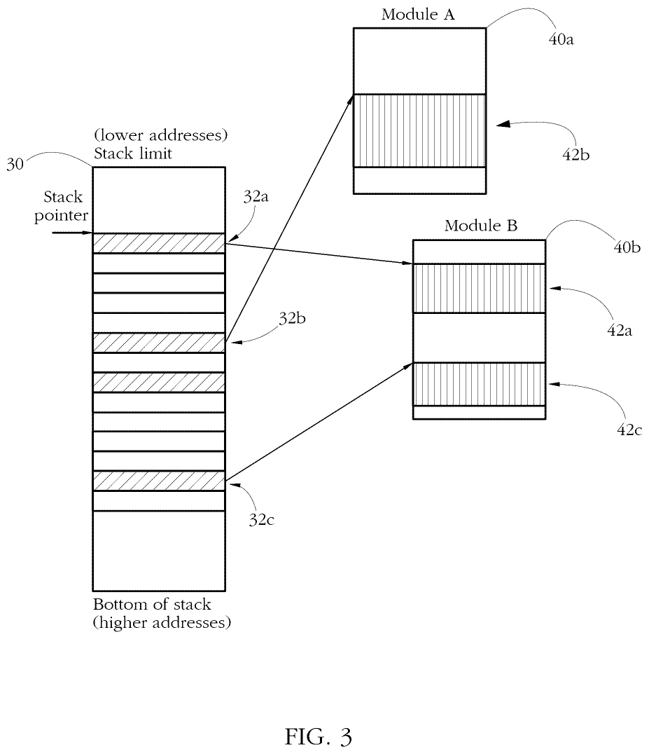

FIG. 3 shows a section of memory occupied by an exemplary call stack 30 according to some embodiments of the present invention. Stack 30 is divided into individual addressable memory units, the size of which is dependent on architecture. For instance, on 32-bit platforms, each illustrated stack unit represents 4 bytes of memory space. Stack 30 is located at a memory address commonly known as the stack pointer, which on x86 platforms is stored in the ESP/RSP register of the hardware processor of host system 10. Each stack unit stores a distinct stack item, which typically comprises an address of a function or a parameter/argument value passed to the respective function. Stack items comprising addresses are herein called stack references. In the example illustrated in FIG. 3, references 32a-c include memory addresses of code chunks 42a-c (e.g., various functions/subroutines and/or shellcode) respectively.

In modem programming paradigms, software is built from a collection of building blocks or modules comprising executable code. Exemplary modules include a main executable of a process (such as an EXE file in Windows®) and a library (such as a dynamic-linked library—DLL in Windows®), among others. Similar kinds of modules may be identified in host systems 10 executing operating systems such as Linux®, or MacOS®. The main executable module of a process typically comprises the first processor instruction of the respective process, executed when the respective process is launched. Libraries are self-contained sections of code implementing various functional aspects of a program. For instance, the NTDLL.DLL library includes a collection of functions implementing various aspects of the Windows® OS, such as a system call interface, among others. Shared libraries may be used independently by more than one program. Modules may be loaded and/or unloaded to/from memory prior to and/or during execution of the respective process.

Each function/code chunk 42a-c called from the stack typically forms a part of a software module (e.g., software library) loaded into memory, such as exemplary modules 40a-b in FIG. 3. Some embodiments explicitly use this observation to identify modules 40a-b according to a content of the call stack, e.g., according to stack references 32a-c. For instance, some embodiments identify modules 40a-b by calling specific APIs of OS 14, e.g., memory mapping utilities that allow identifying software components residing in the vicinity of the address pointed to by each stack reference 32a-c. Alternatively or additionally, some embodiments identify modules 40a-b by parsing specific data structures used by OS 14 to represent and manage currently executing processes and/or threads (e.g., EPROCESS, ETHREAD, and/or virtual address descriptor—VAD data structures in Windows®). Such structures typically include a virtual and/or physical memory address (also termed base address) of each loaded module. By correlating the respective base addresses with the content of stack references 32a-c, some embodiments determine which module 40a-b each stack reference 32a-c points to.

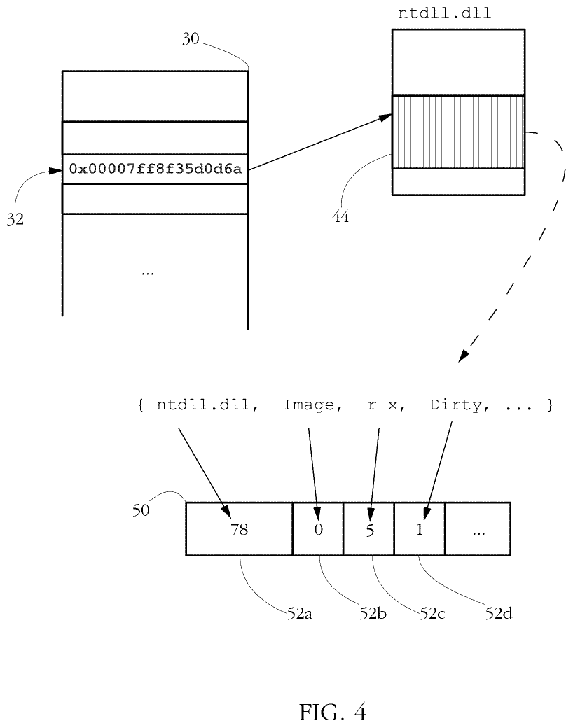

In some embodiments, stack parser 26 is configured to determine a set of forensic indicators characterizing a memory region pointed to by each stack reference. Some forensic indicators may be determined according to a current content of the respective memory region, and others may include various metadata characterizing the respective memory region other than the content of the respective page. As illustrated in FIG. 4, a stack reference 32 (generically representing any of stack references 32a-c in FIG. 3) comprises an address of a location within a memory region 44 currently storing code referenced from the stack. In systems using pageable memory, an exemplary memory region 44 represents an individual memory page. An exemplary page descriptor 50 includes a set of page metadata 52a-d comprising various attributes of region/page 44. A skilled artisan will know that the illustrated format of page descriptor 50 is herein only exemplary and not meant to be limiting.

Exemplary page metadata may include a module identifier 52a comprising an identifier of a software module/library pointed to by the respective stack reference (NTDLL.DLL in the example of FIG. 4). To determine module identifier 52a, some embodiments first determine which software module/library the respective stack reference points to, for instance by calling specific APIs of OS 14, e.g., memory mapping utilities that allow identifying software components residing in the vicinity of the address contained by stack reference 32. Such APIs typically identify modules by name. Some embodiments then map the respective module/library name to a unique numerical identifier (78 in the example illustrated in FIG. 4) using a pre-determined vocabulary of names. The module name vocabulary may include a comprehensive list of module/library names, selected according to a frequency of occurrence in typical software use and/or according to relevance to computer security. An exemplary module name vocabulary for Windows® platforms may include the following tokens, among others:

| | | |
|---|---|---|
| main | ntdll.dll | kernel32.dll |
| kernelbase.dll | wow64.dll | wow64cpu.dll |
| xtajit.dll | ws2_32.dll | wininet.dll |
| xul.dll | chakra.dll | sbiedll.dll |
| security.dll | bxsdk*.dll | python27.dll |

Similar module name vocabularies may be assembled for other platforms and operating systems. Other exemplary members of a module name vocabulary may include dynamic (for a dynamic code region, not part of a loaded module) and anonymous (for a memory image that has no identifiable name).

Additionally or alternatively, some embodiments group modules/libraries into categories, according to a type of functionality the respective module/library provides and/or according to a category of application that the respective module/library belongs to. Exemplary module categories may include, for instance, security, sandbox, kernel, network, just-in-time (JIT) compilation, gaming, packer, and script. In response to mapping a module to its category, some embodiments may include an identifier of the respective category into module identifier 52a, or use the category identifier instead of the module identifier altogether. Some embodiments map modules/libraries belonging to the same category to similar module identifiers 52a, for instance to numbers which are close in magnitude. Such mappings rely on the observation that using similar module identifiers for modules belonging to the same category may result in stack parser 26 transmitting some of that semantics to AI module 28.

Page descriptor 50 may further include indicators of current allocation type of the respective page/region of memory. Allocation type indicates a type of content declared to memory management APIs of OS 14 when allocating memory for the respective object. The allocation type may be stored as a flag, and may be modified following the initial allocation, for instance with malicious purpose (e.g., to hide malicious code). In Windows® platforms, exemplary allocation types include Image (used for allocating memory for a software module/library), Map (used for mapping a file to memory), and Private (used in generic memory allocations). To extract this information, embodiments implemented on Microsoft® Windows® platforms may interrogate the OS memory management functions, or inspect OS data structures such as the VADs. For instance, calling ZwQueryVirtualMemory with the MemoryRegionInformation query code returns the allocation type of the respective memory region/page. Allocation indicators 52b may be then mapped to distinct numbers, with Image corresponding to 0 in the exemplary embodiment of FIG. 4.

Other page metadata included in page descriptor 50 may include an access right indicator 52c indicative of a type of access rights currently set for the respective memory region/page. Access rights indicate for instance whether the respective page is readable, writable, and/or executable. Stack parser 26 may obtain such information for instance from page tables managed by OS 14, which typically include specialized bits indicative of access rights for each respective memory page or region. Alternatively, the access rights may be determined by querying OS memory management functions such as ZwQueryVirtualMemory. Distinct access rights may be mapped to distinct numbers, with ‘ r_x’ (read and execute) corresponding to 5 in the exemplary embodiment in FIG. 4.

Yet other page metadata included in page descriptor 50 may include an access history indicator 52d indicative of whether and/or how the respective region/page has been used since allocation. Exemplary values include Dirty (indicating that the respective page has been modifed or whether its shared status has changed), Locked (indicating that the respective page cannot be swapped out), and Transaction (indicating that the respective page participates in a Windows® TxF file system transaction), among others. Such attributes may be determined by any method known in the art. One such exemplary method checks the page table entry for the respective page and determine whether its dirty bit is set—this works only until the page is swapped out, or until the OS decides to clear that flag. Another exemplary method applicable on a Windows® platform uses the ZwQueryVirtualMemory function of OS 14 with the MemoryWorkingSetExInformation query code—this returns, among others, information regarding the sharing status of that page. If the respective page is no longer shared, it will have the Shared indicator set to false. Similarly, calling ZwQueryVirtualMemory with the MemoryMappedFilenameInformation query code reveals whether the respective page participates in a file transaction.

A skilled artisan will know that page metadata 52a-d are only exemplary, and that other information and/or metadata may be used in addition to, or instead of, the examples above. For instance, in addition to current access rights 52c, some embodiments may determine a set of initial access rights to the respective page (i.e., access rights set at when the respective memory region/page was initially allocated for the current object). Initial access rights may be determined by calling memory management APIs of OS 14. Other metadata may characterize memory at a different granularity. For instance, when a module spans multiple memory pages, some embodiments determine initial access rights for the whole module that includes code pointed to by the current stack reference (i.e., access rights declared when the respective module was loaded into memory). Alternatively, another set of rights may characterize the initial access rights set for the section of code (e.g. .text section of a portable executable—PE) of the respective module. Such additional access rights may convey security-relevant information, for instance allowing a determination of whether the page reference by the call stack has been in any way manipulated since its initial allocation.

Exemplary forensic indicators derived from the current content (as opposed to metadata) of the referenced memory page include indicators of code stored in the vicinity of the address pointed to by the respective stack reference. In the following exemplary sequence of instructions:
ADD EAX, EBX
CALL <CreateProcess>
XOR EAX, EAX
   the call to function CreateProcess creates a stack reference pointing to an address of the instruction immediately following the respective call (XOR EAX, EAX). Some embodiments may therefore include in page descriptor 50 indicators of a set of instructions preceding and/or following the instruction that created the current stack reference. For instance, in some embodiments, page descriptor 50 may store the current content of the memory unit pointed to by the stack reference, and/or the current content of the memory unit storing the ADD EAX, EBX instruction, in the current example. Such forensic indicators augment each stack reference with context which can be informative for malware detection.

In some embodiments, stack parser 26 computes one page descriptor for each reference on the stack, as illustrated in FIG. 6, wherein each page descriptor 50a-c is determined for each respective stack reference 32a-c. The computed page descriptors 50a-c are then assembled into a stack descriptor 60, for instance as distinct rows of an N×M matrix of numbers, wherein N denotes a count of references on the stack, and M denotes the count of page metadata items 52a-d in each page descriptor. An alternative stack descriptor comprises an M×N matrix wherein each page descriptor forms a distinct column. In some embodiments, both the count of stack references and the count of metadata are fixed to some pre-determined values. Alternatively, only the count of metadata is pre-determined, while the count of stack references of may vary, as the stack grows and shrinks over time. The size of stack descriptor 60 may be deliberately chosen to achieve a trade-off between the amount of information provided to AI unit 28 and the computational cost associated with providing all that information. Stated otherwise, larger stack descriptors 60 may produce better verdicts, but an overall worse user experience. In typical embodiments, M is between 2 and 10 (e.g., M=4), while a typical range for N is between 5 and a 100 (e.g., N=64). In situations wherein the current stack has less than N references, the stack descriptor may be zero-padded to the correct size. The relative positions of page descriptors 50 within stack descriptor 60 may be chosen according to the relative position within the stack of the respective stack references. For instance, in preferred embodiments, page descriptors 50 corresponding to consecutive references on the stack form consecutive rows or columns of stack descriptor 60, as illustrated in FIG. 6.

Such a manner of constructing stack descriptor 60 is based on the observation that the relative position of stack references encodes malware-indicative information. Benign stacks tend to have a particular structural logic, and deviations from these benign patterns are often associated with malicious manipulation. For instance, the security verdict depends on whether a piece of shellcode calls NTDLL.DLL or vice versa. Similarly, the verdict may change according to whether a call to KERNEL32.DLL is the first reference on the stack or not.

In some embodiments, AI unit 28 (FIG. 2) receives stack descriptor 60 and outputs a security verdict indicating whether the currently executing process is malicious. FIG. 6 shows an exemplary structure of AI unit 28, comprising a set of artificial neural networks organized as a stack of layers, each layer receiving the output of a previous layer and feeding a next layer of the stack. The stack of neural layers may be generically divided into a first substack of layers herein denoted as an encoder 62 and a second substack of layers herein denoted as a decoder 64.

Encoder 62 receives stack descriptor 60 and outputs an embedding vector 66 comprising a set of numbers collectively amounting to an internal representation of stack descriptor 60. Decoder 64 then determines a verdict 68 according to embedding vector 66. The architectural and functional details of encoder 62 and decoder 64 go beyond the scope of the present description. They can be implemented using any neural network architecture known in the art, for instance a multi-layer perceptron, among others. At a high level, the operation of encoder 62 and decoder 64 typically comprises a sequence of matrix multiplications and evaluations of activation functions, the parameters of which (e.g., synapse weights) are pre-determined by training AI module on a corpus of stack snapshots and associated stack traces.

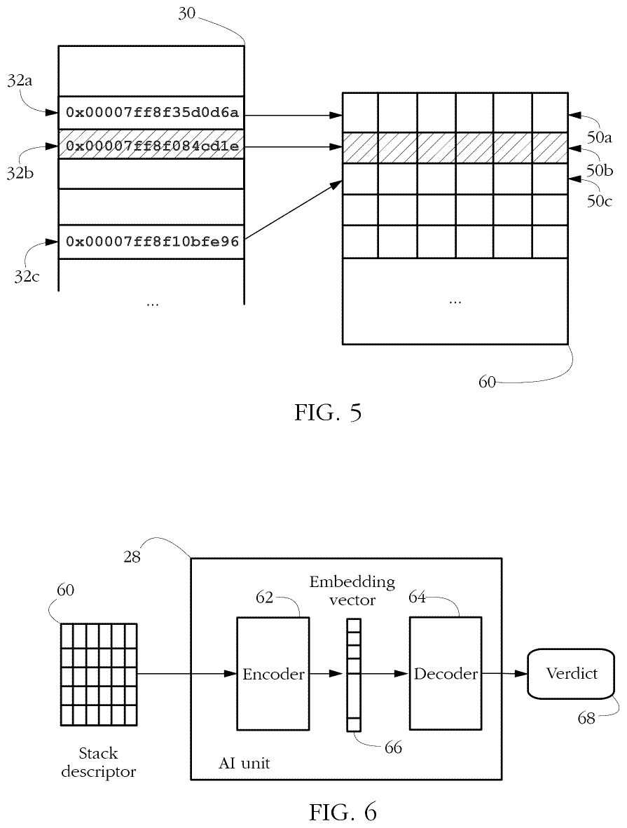

In a preferred embodiment, encoder 62 determines embedding vector 66 according to the value of each page descriptor 50, but also according to values of adjacent page descriptors (representing other references on the stack), and/or further according to the order in which individual page descriptors 50 appear within stack descriptor 60. Stated otherwise, changing the relative position of page descriptors within the stack descriptor (e.g., swapping rows 50a and 50c in the example of FIG. 5) will typically change the value of embedding vector 66. This choice is deliberate, based on the observation that the order/relative position of stack references on the stack is informative to malware detection. Therefore, in some embodiments, encoder 62 implements a neural network architecture which is sensitive to the order of its inputs.

For instance, encoder 62 may comprise a convolutional neural network (CNN) layer. Convolutional layers effectively multiply stack descriptor 60 with a matrix of weights known in the art as a filter, so that each element of the embedding vector 66 has contributions from a selected stack reference, but also from other, adjacent stack references within a neighborhood of a pre-determined size. The embedding vector therefore collectively represents the stack at a granularity that is coarser than that of individual stack references. The filter weights are adjustable parameters which may be tuned during the training process.

Alternatively or additionally, encoder 62 may comprise a recurrent neural network (RNN). RNNs form a special class of artificial neural networks, wherein connections between the network nodes form a directed graph. Several flavors of RNN are known in the art, including long-short-term-memory (LSTM) networks and graph neural networks (GNN), among others. A typical RNN comprises a set of hidden units (e.g., individual neurons), and the topology of the network is specifically configured so that each hidden unit receives an input characterizing a respective page descriptor 50, but also an input provided by an adjacent hidden unit, which in turn receives an input characterizing another page descriptor adjacent to the first. As a result, the output of each hidden unit is influenced not only by the respective stack descriptor 50, but also by the preceding page descriptor within stack descriptor 60. Stated otherwise, an RNN layer may process information about each stack reference in the context of previous stack references. Bi-directional RNN architectures may process information about each stack reference in the context of both previous and subsequent references on the stack.

Other alternative or additional layers of encoder 62 may comprise a stack of transformer neural network layers. The transformer architecture is described, for instance, in A. Vaswani et al., ‘Attention is all you need’, arXiv:1706.03762, among others. When applied in the present setup, transformer layers of encoder 62 produce a contextualized embedding vector encoding information from multiple stack references.

Some embodiments may compute embedding vector 66 as a combination of two vectors, one determined according to values of stack descriptor 60 and another determined according to a position of each value within stack descriptor 60.

In turn, decoder 64 may implement for instance a stack of dense (i.e., fully connected) layers further connected to rectifier (e.g., ReLU or GeLU activation functions) and/or loss layers. The size of each layer and the count of layers of decoder 64 may be chosen to achieve a compromise between the accuracy of the verdict and computational cost.

In some embodiments, verdict 68 indicates whether the currently executing user process (i.e., owner of the respective stack) comprises malware. Verdict 68 may for instance comprise a Boolean number (e.g., 0/1, YES/NO), or a continuous variable indicating a likelihood of malware.

In some embodiments, AI unit 28 is pre-trained to distinguish between malicious and benign stack descriptors, using a large corpus of pre-labelled stack descriptors. To keep up with emerging threats, the training corpus may be continuously refreshed with stack descriptors derived from newly acquired both malicious and benign samples, and re-training sessions may be carried out periodically or triggered by the discovery of new malware. Training herein denotes feeding items of the training corpus to a training instance of AI unit 28 and adjusting internal parameters of AI unit 28 to decrease any discrepancy between an output of unit 28 and a pre-determined, reference output (e.g., clean/malicious). Training may follow any algorithm known in the art of machine learning, such as a version of backpropagation, genetic algorithms, etc. Following training, neural network parameters such as synapse weights etc. may be transmitted to client devices as software updates.

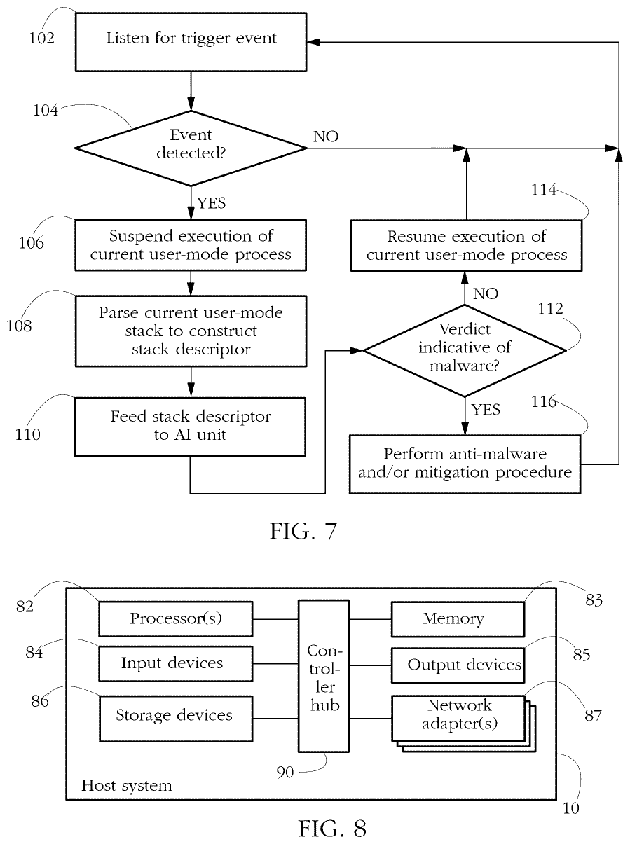

FIG. 7 shows an exemplary sequence of steps carried out by security application 20 to protect host system 10 against malware in some embodiments of the present invention. A sequence of steps 102-104 uses event detector 22 to listen for computing events indicative of a specific stage in the lifetime of an executable entity, herein deemed ‘inspection point’. For more about trigger events and inspection points, please see description of event detector 22 in relation to FIG. 2.

In response to detecting a trigger event (step 104 returns a YES), a step 106 effectively suspends the execution of the respective user-mode entity/process. In a further step 108, stack parser 26 (FIG. 2) walks the current user-mode stack and constructs stack descriptor 60 as described in detail below. Preferred embodiments analyze only the latest N stack references (e.g., N=64). When the stack is shorter, stack descriptor 60 may be zero-padded to the required size.

In a further step 110, stack descriptor 60 is fed to AI unit 28, which outputs verdict 68. A step 112 determines whether the verdict indicates a likelihood of malice, and if no, a further step 114 resumes execution of the respective user-mode process. In case of a verdict of malice, a step 116 may perform mitigation procedures, such as quarantining the offending process, notifying the user, etc. In some embodiments, step 116 further comprising transmitting a copy of the current stack descriptor 60 to a remote security server for analysis, thus assisting in the discovery and reporting of emerging malware.

Transmitting stack descriptor 60 to a central server collecting data from a multitude of clients may further solve the problem of false positives, i.e., samples inaccurately labeled as malicious. The security server may maintain a list of such samples indexed according to the stack descriptor, and may communicate back to the respective client, reversing the verdict determined by the local AI unit.

Some embodiments further implement an optimization strategy by using a cache to avoid unnecessary invocations of AI unit 28, which may otherwise carry a substantial computational cost. Said cache may store a plurality of stack descriptors 60, each with its associated verdict 68. The exemplary method illustrated in FIG. 7 may thus be modified by introducing an extra step in between steps 108 and 110, wherein security application 20 may check whether the current stack descriptor is already present in the cache, and executing step 110 only if no. When a verdict for the respective stack descriptor is already known, execution may pass directly on to step 112.

To facilitate cache lookup, some embodiments implement a hashing scheme wherein the cache stores a hash instead of the stack descriptor itself. One exemplary hashing scheme comprises flattening stack descriptor 60 into a vector and applying a hash function such as a version of a cyclic redundancy check (CRC) or secure hash algorithm (SHA) to the respective vector, resulting in a hash value uniquely associated with the respective stack descriptor.

Alternatively or additionally, several other hashes may be determined, such as hashing performed selectively, on specific aspects of the stack. In one such example using the illustration in FIG. 5, wherein each row of stack descriptor 60 comprises a distinct page descriptor 50, a hash determined on each column of stack descriptor 60 may single out a specific type of metadata across all references present on the stack. One hash may collectively represent all module names referenced from the hash, another hash may collectively represent allocation types of all memory pages referenced by the stack, etc. Yet another exemplary hashing scheme may determine an N×1 vector of hashes, wherein each element comprises a hash of a respective page descriptor 50.

Beside accelerating the operation of security application 20, such additional hashes may be used in malware research, for instance to better understand various types of attack, based on the observation that such hashes convey substantially more information than a hash of the whole stack descriptor. Using multiple hashes may for instance enable grouping various samples according to a similarity of their stack traces and identifying samples which are very similar but nonetheless have opposing verdicts.

Typical embodiments of the present invention may be implemented as software (computer programs) executing on a hardware processor of host system 10. However, a skilled artisan will know that alternatively, the methods described herein may be implemented in dedicated hardware, for instance a field-programmable gate array (FPGA) or an application-specific integrated circuit (ASIC), or as a combination of hardware and software.

FIG. 8 shows an exemplary hardware configuration of a host system 10 programmed to execute some of the methods described herein. The illustrated host system is a personal computer; other electronic devices such as servers, mobile telephones, tablet computers, and wearables may have slightly different configurations.

Processor(s) 82 comprise a physical device (e.g. microprocessor, multi-core integrated circuit formed on a semiconductor substrate) configured to execute computational and/or logical operations with a set of signals and/or data. Such signals or data may be encoded and delivered to processor(s) 82 in the form of processor instructions, e.g., machine code.

Memory unit 83 may comprise volatile computer-readable media (e.g. dynamic random-access memory—DRAM) storing data/signals/instruction encodings accessed or generated by processor(s) 82 in the course of carrying out operations. Memory 83 is organized into pages, each page further comprising multiple individually addressable storage units. Input devices 84 may include computer keyboards, mice, and microphones, among others, including the respective hardware interfaces and/or adapters allowing a user to introduce data and/or instructions into host system 10. Output devices 85 may include display devices such as monitors and speakers among others, as well as hardware interfaces/adapters such as graphic cards, enabling the respective host system to communicate data to a user. In some embodiments, input and output devices 84-85 share a common piece of hardware (e.g., a touch screen). Storage devices 86 include computer-readable media enabling the non-volatile storage, reading, and writing of software instructions and/or data. Exemplary storage devices include magnetic and optical disks and flash memory devices, as well as removable media such as CD and/or DVD disks and drives. Network adapter(s) 87 enable host system 10 to connect to an electronic communication network and/or to other devices/computer systems.

Controller hub 90 generically represents the plurality of system, peripheral, and/or chipset buses, and/or all other circuitry enabling the communication between processor(s) 82 and the rest of the hardware components of host system 10. For instance, controller hub 90 may comprise a memory controller, an input/output (I/O) controller, and an interrupt controller. Depending on hardware manufacturer, some such controllers may be incorporated into a single integrated circuit, and/or may be integrated with processor(s) 82. In another example, controller hub 90 may comprise a northbridge connecting processor 82 to memory 83, and/or a southbridge connecting processor 82 to devices 84, 85, 86, and 87.

The exemplary systems and methods described herein are designed to prevent the most advanced malware attacks that target user-mode processes: exploits, code injections, privilege escalations, and evasion techniques, while minimizing the impact on system stability, performance, and user experience.

Embodiments of the present invention employ AI technologies such as artificial neural networks to discern between benign and malicious stack traces. A stack parser walks the call stack of the target software entity and for each address on the stack, extracts a set of metadata characterizing a memory page containing said address. A data structure comprising page metadata computed from multiple stack references is then fed to an artificial neural network pre-trained to distinguish between malicious and benign stack traces.

Exemplary page metadata includes the name of a software module/library residing within the respective page, access rights to the respective page, and an allocation type of the respective page, among others, relying on the observation that such metadata is informative as to whether the respective memory region has been maliciously manipulated, as typically happens in attacks such as module stomping and DLL swapping.

Conventional anti-malware methods relying on the call stack typically analyze each stack reference individually. However, advanced malware may use a sequence of apparently innocuous actions to dissimulate its payload within legitimate software modules and libraries and thus evade detection. In contrast to such conventional methods, some embodiments of the present invention analyze the call stack as a whole, i.e., multiple stack references in context, therefore being able to detect malware-indicative patterns across the entire call stack.

The stack as a whole comprises substantially more insight than individual entries taken in isolation, instead encoding an entire chain of events leading to the respective inspection point. To give a simple example, stack references pointing into modules A. DLL and NTDLL.DLL, when taken in isolation, typically yield information only about the identity of the respective modules and the attributes of the respective memory regions (what code is currently being executed, is this execution allowed, etc.). However, if the reference to NTDLL.DLL directly follows the reference to A. DLL and the former is the latest entry on the stack, the two references taken together convey a lot of additional security-related information. Said sequence of stack references indicates that A. DLL has called NTDLL.DLL, which then made a syscall to the kernel. The sequence is suspicious, because to trigger a syscall, legitimate software typically calls KERNEL32.DLL (i.e., a documented OS API, which in turn calls NTDLL.DLL), as opposed to calling NTDLL.DLL directly.

Conversely, a stack reference pointing to a memory region R allocated as Private and having rwx access rights is highly suspicious when taken in isolation. Such situations usually indicate malicious code (e.g., shellcode) hiding for instance inside a non-executable data file. However, a sequence of stack references indicating that the suspicious reference was called by NTDLL.DLL, and that code from the region R further calls a security software module is completely benign, corresponding to a hook placed by security software. Both these examples show a reversal of the malware verdict between analyzing references in isolation and in context.

Following such insight, the architecture of the neural network is herein deliberately chosen to process to data in context. For instance, metadata characterizing a selected stack reference is analyzed together with metadata from adjacent stack references. Some embodiments explicitly consider the relative positions and/or the order in which the respective references reside on the stack. A useful intuitive analogy connects stack descriptors 60 as described herein (see e.g., FIG. 5) with digital images, wherein each pixel {i,j}represents specific metadata j determined for a specific reference i on the stack. Some embodiments may therefore use a neural architecture adapted from AI-based image classifiers (e.g., convolutional neural networks). To emphasize the order of references on the stack, some embodiments may further use architectures adapted from natural language processing, such as recurrent neural networks or transformers, among others.

The use of AI as part of security software may place a substantial computational burden on the host system, negatively affecting user experience and productivity. Some embodiments therefore choose to execute the expensive calculations associated with AI only at carefully selected stages within the lifecycle of a target entity, known herein as inspection points. Such ‘inspection points’ are selected for being particularly informative of whether the respective entity is malicious or not. Stated otherwise, any malicious code is most likely to be present within the memory space of the respective entity and actually executing at such inspection points. Therefore, by carrying out an analysis of the entity's memory space at the respective moment/stage, some embodiments can detect whether the current action of the respective entity took place in a malicious context, or if the respective entity has been compromised.

To further minimize computational cost, some embodiments employ a cache storing an identifier (e.g., hash) of recently computed stack descriptors and their associated verdicts. Such caching prevents repeat determinations of verdicts for new instances of familiar stack traces, and may further help avoid false positives by storing correct verdicts for stack traces that the AI unit inadvertently misclassifies.

It will be clear to one skilled in the art that the above embodiments may be altered in many ways without departing from the scope of the invention. Accordingly, the scope of the invention should be determined by the following claims and their legal equivalents.

1. A computer system comprising at least one hardware processor configured to execute:
a stack parser executing concurrently with a target process and configured to, in response to an occurrence of a trigger event caused by an execution of the target process, determine a stack descriptor characterizing a plurality of stack references of a call stack of the target process, wherein for each stack reference of the plurality of stack references, the stack descriptor comprises a plurality of metadata characterizing a memory page pointed to by the each stack reference; and
an artificial neural network configured to determine whether the computer system comprises malicious software according to the stack descriptor.

2. The computer system of claim 1, wherein the stack descriptor includes an identifier of a software module currently residing within the memory page.

3. The computer system of claim 1, wherein the plurality of metadata is indicative of an allocation type of the memory page.

4. The computer system of claim 1, wherein the plurality of metadata is indicative of access rights currently controlling access to the memory page.

5. The computer system of claim 1, wherein the memory page currently stores a part of a software module and wherein the plurality of metadata is indicative of initial access rights controlling access to the memory page, the initial access rights defined when the memory page was allocated to store the software module.

6. The computer system of claim 1, wherein the memory page currently stores a part of a software module having multiple sections, a selected section comprising executable code, and wherein the plurality of metadata is indicative of access rights controlling access to the selected section.

7. The computer system of claim 1, wherein the plurality of metadata is indicative of whether the memory page has been modified since allocation.

8. The computer system of claim 1, wherein the plurality of metadata is indicative of whether the memory page participates in a file system transaction.

9. The computer system of claim 1, wherein the stack descriptor is indicative of a position of the stack reference on the call stack relative to other stack references of the plurality of stack references.

10. The computer system of claim 1, wherein the artificial neural network comprises an item selected from a group consisting of a convolutional neural network, a recurrent neural network, and a transformer neural network.

11. An anti-malware method comprising employing at least one hardware processor of a computer system to:
in response to an occurrence of a trigger event caused by an execution of a target process, determine a stack descriptor characterizing a plurality of stack references of a call stack of the target process, wherein for each stack reference of the plurality of stack references, the stack descriptor comprises a plurality of metadata characterizing a memory page pointed to by the each stack reference; and
employ an artificial neural network unit to determine whether the computer system comprises malicious software according to the stack descriptor.

12. The method of claim 11, wherein the stack descriptor includes an identifier of a software module currently residing within the memory page.

13. The method of claim 11, wherein the plurality of metadata is indicative of an allocation type of the memory page.

14. The method of claim 11, wherein the plurality of metadata is indicative of access rights currently controlling access to the memory page.

15. The method of claim 11, wherein the memory page currently stores a part of a software module and wherein the plurality of metadata is indicative of initial access rights controlling access to the memory page, the initial access rights defined when the memory page was allocated to store the software module.

16. The method of claim 11, wherein the memory page currently stores a part of a software module having multiple sections, a selected section comprising executable code, and wherein the plurality of metadata is indicative of access rights controlling access to the selected section.

17. The method of claim 11, wherein the plurality of metadata is indicative of whether the memory page has been modified since allocation.

18. The method of claim 11, wherein the plurality of metadata is indicative of whether the memory page participates in a file system transaction.

19. The method of claim 11, wherein the stack descriptor is indicative of a position of the stack reference on the call stack relative to other stack references of the plurality of stack references.

20. The method of claim 11, wherein the artificial neural network comprises an item selected from a group consisting of a convolutional neural network, a recurrent neural network, and a transformer neural network.

21. A non-transitory computer-readable medium storing instructions which, when executed by at least one hardware processor of a computer system, cause the computer system to form:
a stack parser executing concurrently with a target process and configured to, in response to an occurrence of a trigger event caused by an execution of the target process, determine a stack descriptor characterizing a plurality of stack references of a call stack of the target process, wherein for each stack reference of the plurality of stack references, the stack descriptor comprises a plurality of metadata characterizing a memory page pointed to by the each stack reference; and
an artificial neural network configured to determine whether the computer system comprises malicious software according to the stack descriptor.
